(19) United States
(12) Patent Application Publication
(10) Pub. No.: US 2024/0120589 A1
(43) Pub. Date: Apr. 11, 2024

(54) Storage Housing for an Electrical Energy Store of a Motor Vehicle

(71) Applicant: Bayerische Motoren Werke Aktiengesellschaft, Muenchen (DE)

(72) Inventors: Jan DANNEBERG, Muenchen (DE); Maximilian GERSTBERGER, Muenchen (DE); Ronny GROSSE, Eichenau (DE); Martin SCHUSTER, Muenchen (DE); Peter WIMMER, Muenchen (DE)

(21) Appl. No.: 18/276,898

(22) PCT Filed: Feb. 24, 2022
(86) PCT No.: PCT/EP2022/054670

§ 371 Date: Aug. 11, 2023

(30) Foreign Application Priority Data
Mar. 19, 2021 (DE) 10 2021 106 800.2

(51) Int. Cl. H01M 50/204; B60L 50/60; B60L 50/64; H01M 50/188; H01M 50/224; H01M 50/249

(52) U.S. Cl. CPC H01M 50/204; B60L 50/64; B60L 50/66; H01M 50/188; H01M 50/224; H01M 50/249

(57) ABSTRACT

A storage housing for an electrical energy store of a motor vehicle includes at least one housing part having a circumferential sealing flange, at which the housing part can be connected to at least one additional housing part of the storage housing, The one housing part is formed by a steel frame which is connected to a closing part made of a light metal material, in particular an aluminum material. In order to create a housing part which is optimized in terms of its weight and also in terms of simplicity and sealing, it is provided that the steel frame is designed as a single-piece shaped component made of a steel material.

### BACKGROUND AND SUMMARY

The invention relates to a storage housing for an electrical energy store of a motor vehicle. The invention furthermore relates to an energy store floor assembly for an electrically powered motor vehicle with such a storage housing.

EP 3 486 101 B1 has already disclosed that at least one housing part of a storage housing for an electrical energy store of a motor vehicle is composed from a plurality of components. Here, a steel frame, running all round the outer periphery, is made of profiled parts and corner parts, between which extend respective crossmembers and longitudinal members. A closing part, which may for example be made of a light metal material, can be placed on this steel frame. On the side opposite the closing part, the steel frame has a peripheral sealing flange, via which the housing part can be connected to a further housing part in order to form the storage housing.

In addition, the prior art already discloses storage housings made of pure aluminum, but these are however very complicated and hence cost-intensive. In particular, such aluminum structures are particularly complex since they have many joining points to the other housing part in the region of the sealing flange, and accordingly considerable effort is required to obtain a sealed storage housing. Also, storage housings are available made of steel, which only meet the requirements with respect to side impact, loading from below or corrosion protection with very many special measures taking up corresponding installation space.

The object of the present invention is to provide a storage housing and an energy store floor assembly of the type cited initially, which are firstly optimized with respect to weight and secondly guarantee the required tightness of the storage housing in a simple and reliable fashion.

This object is achieved according to the invention by a storage housing and by an energy store floor assembly, in accordance with the independent claims. Favorable refinements of the invention are the subject of the dependent claims.

The storage housing according to the invention for an electrical energy store of a motor vehicle comprises at least one housing part having a peripheral sealing flange, at which the housing part can be connected to at least one additional housing part of the storage housing, wherein the at least one housing part is formed by a steel frame connected to a closing part made of a light metal material, in particular an aluminum material.

To obtain a housing part which is optimized with respect to weight and also with respect to simplicity and tightness, according to the invention it is provided that the steel frame is designed as a one-piece shaped component made of a steel material. According to the invention therefore, a mixed construction of a steel frame and an alloy closing part, in particular an aluminum closing part, is provided, wherein the resulting housing part is connected at the peripheral sealing flange to at least one further housing part in order to form the storage housing. The core of the invention is here to achieve a peripheral one-piece sealing flange by means of the steel frame formed as an integral shaped component of steel material, the production of which is far simpler than that of a sealing flange of the previously known frame from EP 3 486 101 B1, which is composed of a plurality of frame components and accordingly has a sealing flange which must be processed in complex fashion at the joining points of the frame parts in order to guarantee the tightness of the storage housing. In contrast, the one-piece shaped component according to the invention as a steel frame allows a sealing flange which is much easier to produce, requires far less processing complexity and hence guarantees the tightness of the storage housing in an economic and reliable fashion. At the same time, because of the mixed construction of a steel frame with a light metal closing part, a storage housing can be produced which is extremely favorable in terms of weight. A further advantage is that by the use of a steel frame, the further housing part can also easily be made of a steel material. Also, the storage housing can thus be attached more easily to a steel body of a motor vehicle, e.g. at its side sills, without complex corrosion measures.

In a further embodiment of the invention, it is provided that the steel frame has a continuous sealing flange.

A further advantageous embodiment of the invention provides that the housing part is formed as a housing lower part and the closing part as a floor. The design of the housing lower part in such a mixed construction is particularly advantageously since, in this way, the advantages of the steel frame with respect to tightness of the storage housing can be utilized and at the same time a light metal material, in particular an aluminum material, can be used as the floor, in order e.g. to optimize the properties of the housing lower part with respect to driving over bollards or similar force loading due to special events or abuse.

It has furthermore proved advantageous if the steel frame is coated with a cathodic dip-coating and is connected to the further housing part, in particular the housing upper part, via an adhesive forming a seal. In this way, in particular, it is possible to use adhesive acting as an applied liquid sealant.

It has furthermore proved advantageous if the steel frame is connected to the closing part by an adhesive and by mechanical connecting means, in particular half-hollow punch rivets. With such an adhesive, a tightness between the steel frame and the closing part can be achieved in a simple fashion. The mechanical connecting means, in particular half-hollow punch rivets, here locally create a connection between the steel frame or the further frame structure and the closing part, which merely spot-loads the connection locally and accordingly does not cause any distortion within the housing part, in particular the housing lower part.

In a further embodiment of the invention, an energy absorption element of a steel material is attached on each of the outer long sides of the steel frame. Such energy absorption elements, which for example may be formed of steel material as roll profiles or similar, are highly effective in particular as protection against side impacts.

A further advantageous embodiment of the invention provides that aluminum carrier elements connected to the closing part or floor are arranged inside the steel frame, and the aluminum carrier elements are connected to the steel frame by steel adapters. Such aluminum carrier elements contribute to a particularly low-weight stiffening of the housing part, in particular the housing lower part, and can be connected to the steel frame easily via corresponding steel adapters, taking into account a corresponding corrosion protection.

The advantages described in connection with the storage housing according to the invention apply similarly to the energy store floor assembly according to claim 7.

The energy store floor assembly is furthermore distinguished by at least one respective energy absorption element which is arranged below the side sill and formed separately from the storage housing, and which can easily be scaled and adapted to different peripheral conditions such as the weight of the energy store, the total weight of the vehicle, the structure of the vehicle and similar.

In a further embodiment of the invention, it has proved advantageous if these energy absorption elements are configured as extruded aluminum profiles. Such extruded aluminum profiles are cheap to produce and can easily be scaled according to requirements.

Further features of the invention arise from the claims, the figures and the description of the figures. The features and feature combinations mentioned in the description above, and the features and feature combinations listed below in the description of the figures and/or shown only in the figures, can be used not only in the respective combination given but also in other combinations or alone.

The invention is now explained in more detail with respect to a preferred exemplary embodiment and with reference to the drawings.

### BRIEF DESCRIPTION OF THE DRAWINGS

FIG. 1 is a schematic perspective view of a housing lower part of a storage housing for an electrical energy store of a car with a steel frame produced as a one-piece shaped component, which is connected to a closing part of aluminum material;

FIG. 2 shows, in extract and perspective, a sectional view of a long side of the housing lower part from FIG. 1, wherein respective spacer rings can be seen, by which the housing lower part or the storage housing can be connected to laterally corresponding side sills of the motor vehicle body, and wherein also an energy absorption element formed as an extruded profile can be seen which is connected directly to the corresponding side sill via respective illustrated bushes;

FIG. 3 shows, in extract, a sectional view through the storage housing and the corresponding side sill to which the storage housing is attached, and also a sectional view through the laterally corresponding energy absorption elements;

FIG. 4 shows, in extract, a perspective view of a fastening point of an aluminum crossmember stiffening the housing lower part, which is attached to the steel frame by means of respective steel adapters; and

FIGS. 5a-5c show, in extract, sectional views of the fastening of the storage housing to the vehicle body in the region of a side sill on the corresponding vehicle side, wherein FIG. 5a shows the arrangement and fastening of a profile on the outside of the steel frame of the housing lower part, FIG. 5b shows the fastening of the housing lower part or storage housing to the side sill, and FIG. 5c shows the subsequent fastening of the extruded profiles, formed as energy absorption elements, to the corresponding side sill separately from the storage housing.

### DETAILED DESCRIPTION OF THE DRAWINGS

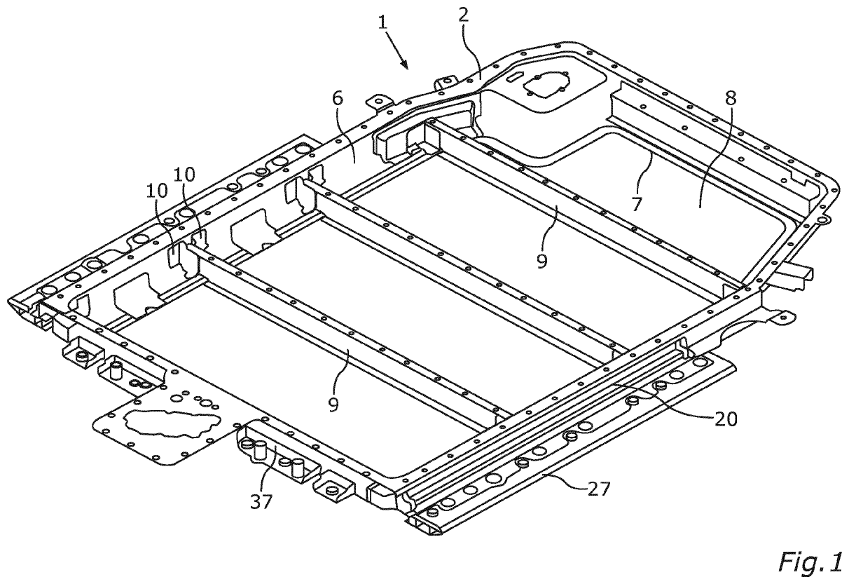

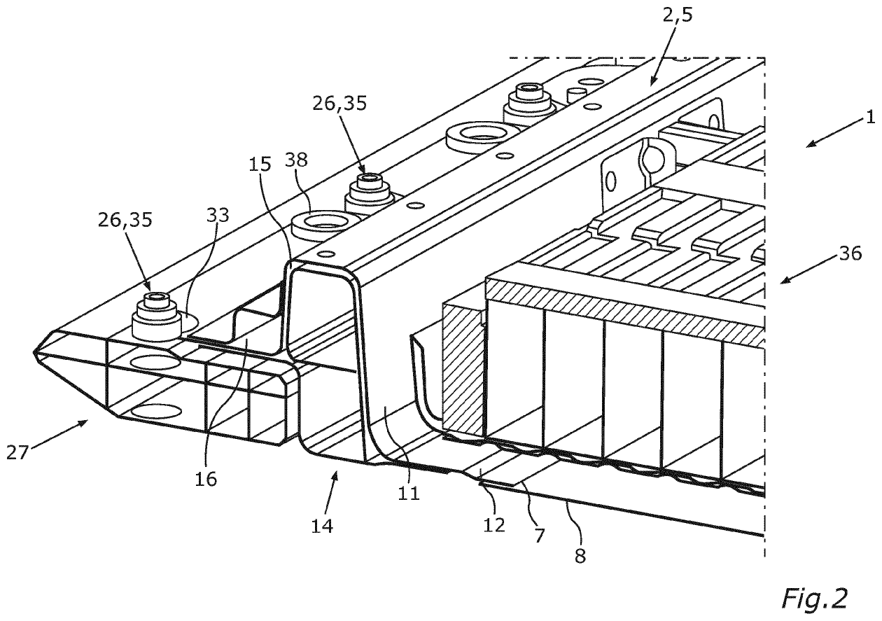

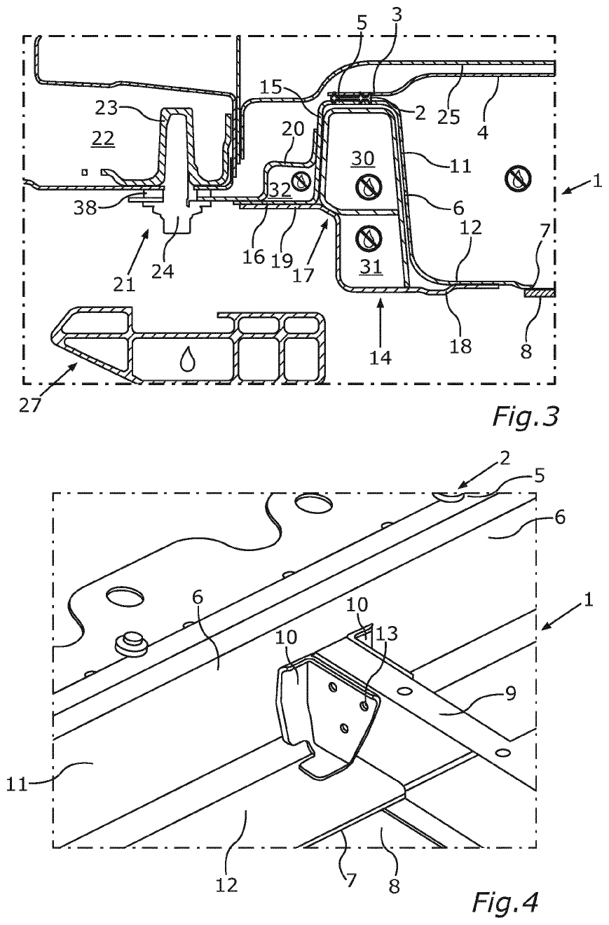

FIG. 1 shows in a perspective view a housing lower part 1 for a storage housing of an electrical energy store 36 (FIG. 2) of a motor vehicle. This housing lower part 1 is equipped, in a fashion to be described, with a peripheral sealing flange 2, via which it can be connected to a sealing flange 3 (indicated in FIG. 3) of a housing upper part 4 via a seal 5.

In the present case, the housing lower part 1 has a steel frame 6 which is here formed as a one-piece shaped component of a steel material, for example a BH steel. The steel frame 6 may be deep-drawn in one or more passes. The steel frame 6 in this case has a central opening 7 which is closed by a closing part 8 made of a light metal material, in particular an aluminum material. The closing part 8 in this case is formed for example from an aluminum sheet of material AL6-OUD or similar. Naturally, other aluminum or light metal sheets and also other plate elements of light metal material are conceivable.

In the present case, the closing part 8 is subjected to a cathodic dip-coating before connection to the steel frame 6, and accordingly is provided with a corresponding coating. Alternatively, the closing part 8 may also be passivated. Then, the closing part 8 is connected to the steel frame 6 via an adhesive forming a seal. In addition, for example mechanical connecting means may be used, in particular half-hollow punch rivets, to connect the steel frame 6 to the closing part 8. Following connection, the steel frame 6 and the closing part 8 are again subjected to a cathodic dip-coating.

To stiffen the housing lower part 1 or closing part 8, also aluminum carrier elements 9 are provided which are formed for example by shaped aluminum sheets or as extruded profiles, and connected to the closing part 8 by bonding and/or for example by half-hollow punch rivets. The connection of the respective carrier elements 9 to the steel frame 6, which is particularly decisive with respect to corrosion, takes place via respective steel adapters 10, which are connected on one side for example by joining to a vertical leg 11 and to a horizontal leg 12 of the steel frame 6. The steel adapters 10 are connected to the respective aluminum carrier frame 9 e.g. via mechanical connecting means at corresponding openings 13. In particular, flow-drilling bolts or similar may be used here. As an alternative to the carrier elements provided here, which in particular may be configured as extruded profiles or shaped components of aluminum sheet, for example rolled high-strength steel profiles may also be used. Then, corresponding steel adapters 10 may have to be avoided, but these steel profiles may in some cases also be connected to the steel frame 6 directly by joining, in particular also by welding.

Together with FIGS. 2 and 3, which respectively show the housing lower part 1 in extract, in a perspective sectional view in the region of one of the vehicle outsides, or the arrangement of the storage housing on the vehicle body in extract, in a sectional view along a section plane running in the vehicle vertical direction or vehicle transverse direction, now the lateral design of the housing lower part 1 and the fastening of the storage housing in the region of the vehicle outside will be discussed.

As evident from FIGS. 2 and 3, a crash profile 14 is arranged from the outside on the leg 11 running in the vehicle vertical direction, and extends at least over a majority length region of the respective vehicle outside of the housing lower part 1 or storage housing. This crash profile 14 is for example made of high-strength or ultrahigh-strength steel, e.g. CP steel, and produced by roll-forming or similar shaping methods. It is also evident that the leg 11 running in the vehicle vertical direction transforms into the sealing flange 2 and then, with a wall region 15, extends downward in the vehicle vertical direction before adjoining a further flange 16 running in the vehicle transverse direction or horizontally. The crash profile 14 is here configured such that firstly it is surrounded by a profiled region 17 of the leg 11, the sealing flange 2 and the wall region 15 on the outer periphery. Also, the crash profile 14 has an inner flange 18 which is connected to the leg 12 of the steel frame running in the vehicle transverse direction and at least substantially horizontally, and a flange 19 which is connected to the flange 16 of the steel frame 6.

It is furthermore evident that, on the outside of the wall region 15 and on the top of the flange 16 of the steel frame 6, a further respective lateral profiled part 20 is attached e.g. by welding or another joining connection, and is made for example of the same material as the crash profile 14. Via this profiled part 20, the housing lower part 1 or the storage housing as a whole is attached by means of respective screw connections 21 to laterally corresponding side sills 22 of the car. The respective screw connection 21 for this comprises a threaded bush 23 which is arranged on the inside of the side sill 22 and receives a screw 24. The flange of the profiled part 20 is here supported on the underside of the side sill 22 via a washer or similar supporting element 38.

In the same way as the lateral profiled parts 20, respective profiled parts 37 are attached to the front and rear end of the steel frame 6 by welding or another joining connection. FIG. 1 shows only the front profiled part 37, which is connected to a front thrust area and/or a front crossmember. The rear profiled part (not shown) is for example connected indirectly to the floor assembly of the vehicle body and to a rear axle carrier.

FIG. 3 also shows, on top of the sealing flange 2, the sealing flange 3 of the housing upper part 4, which is placed on the housing lower part 1 and tightly sealed against this. The housing upper part 4 may e.g. be formed as a steel cover and accordingly be connected in simple fashion to the housing lower part 1. Above the housing upper part 4, a vehicle floor 25 or associated carrier elements can be seen, which extend between the respective side sills 22 of the floor assembly of the vehicle body.

FIGS. 2 and 3 furthermore show a reinforcing and energy absorption element 27, which takes the form of an extruded aluminum profile and is formed on the side sill 22 separately from the storage housing and the side sill 22, and which can be attached via respective screw connections 26 (shown in FIG. 2) to the underside of the respective side sill 22 and also to the underside of the flange 16 of the housing lower part 1. The flange 16, as evident in FIG. 2, here has respective cutouts 28 so that the crash profile 27 can be attached to the side sill 22 separately from the storage housing or housing lower part 1. On subsequent removal of the storage housing or housing lower part 1 from the side sill 22, accordingly firstly the energy absorption element or crash profile 27 can be removed. For this, the crash profile 27 has passage cutouts 29 (shown in FIG. 2), so that the respective screw connection 28 is accessible from below.

Alternatively, the crash profile 27 may however also be fastened to the storage housing, for example the housing lower part 1, and attached jointly therewith to the floor assembly, in particular the side sills 22.

By use of the crash profile 27 mounted on the side sill 22, the crash performance can be optimized significantly, in particular with respect to side impact on a post, and in particular scaled. This means that, depending on the size of the energy store 36 or storage housing, and depending on vehicle weight, vehicle construction or other criteria, an individually adaptable crash profile 27 is selected which is formed for example and in particular as an extruded aluminum profile. Thus in simple fashion, the dimensions, wall thicknesses and chamber profiles of the crash profile 27 can be dimensioned and set so as to obtain optimal crash performance.

It is furthermore evident from FIG. 3 that both the interior of the storage housing itself, and the respective chambers 30, 31, 32 of the crash profile 14 attached on the outside of the leg 11 of the steel frame 6, are formed as dry spaces. Respective hollow chambers of the crash profile 37 at the front and rear on the steel frame 6 are also configured as dry spaces in the exemplary embodiment shown. The respective hollow chambers of the crash profile 27 made of aluminum however are, in the present case, configured as wet spaces.

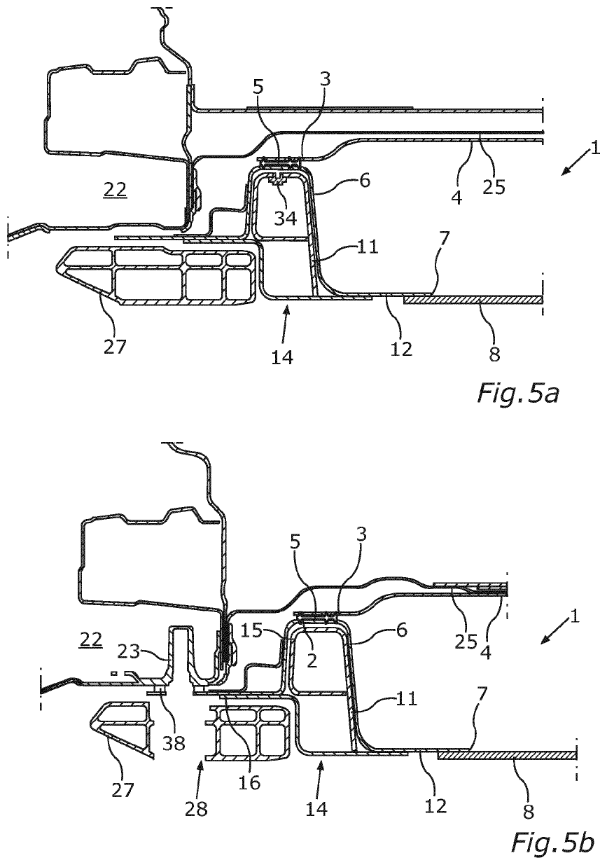

As a whole, it is evident from FIGS. 1 to 4 that the one-piece design of the steel frame 1 allows a one-piece or peripheral and continuous sealing flange 2 to be achieved, which is formed without joining points and accordingly allows a particularly favorable continuous seal 5. The sealing flange 2 in this case is arranged at least substantially in a horizontal plane or plane running in the vehicle transverse direction and in the vehicle longitudinal direction. At the same time however, a three-dimensional course of the sealing flange 2 is conceivable. A further advantage of such a sealing flange 2 of a steel material is that also the housing upper part 4 can easily be made of a steel material with the corresponding sealing flange 3. Use of the closing part 8, which is formed as a floor or floor plate of a light metal material, in particular aluminum material, perfectly fulfils the requirements with respect to bollard protection, i.e. protection from damage from below, and optimization with respect to corrosion protection. Furthermore, the closing part 8 allows optimum weight saving. The closing part 8 can easily be connected to the steel frame 6 and the aluminum carrier elements 9 by bonding and/or by mechanical connecting means such as half-hollow punch rivets.

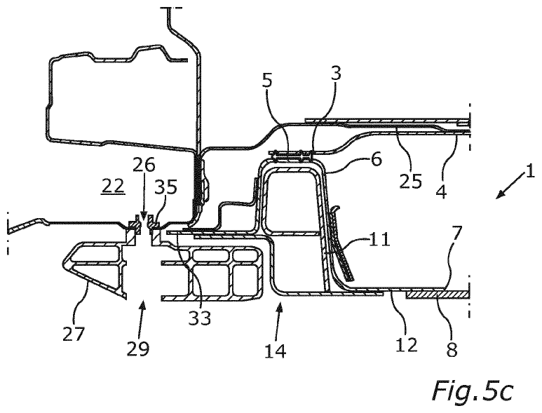

FIGS. 5a to 5c show, respectively in extract and in sectional views along section planes running in the vehicle vertical direction or vehicle transverse direction, the arrangement of the storage housing and the crash profile 27 on the vehicle floor assembly or on the corresponding side sill 22, in a slightly modified embodiment. To avoid repetition, therefore only the differences are discussed.

In the present case, the housing lower part 1 or its steel frame 6 has a flange 16 which adjoins the wall portion 15, extends in the vehicle transverse direction and horizontally to below the side sill 22, and accordingly—as shown in FIG. 5b—serves for fastening of the storage housing to the vehicle body. In contrast to the embodiment of FIGS. 1 to 4, accordingly in this case the steel frame 6 is directly connected to the corresponding side sill 22. In this way, in particular, joining points which may leak can be avoided. FIG. 5b again shows in particular that the flange 16 of the steel frame 6 can be attached to the side sill 22 by means of the screw connection 21 (screw 24, washer 38). To ensure that the screw connection 21 is accessible, corresponding cutouts 28 are provided in the crash profile 27.

FIG. 5a firstly again explicitly shows and marks the seal 5 on the sealing flange 2 of the housing lower part 1. It is furthermore evident how the crash profile 14 may be arranged on the outside of the leg 11 of the housing lower part 1. This may for example take place by a unilateral joining method between the steel frame 6 and crash profile 14, e.g. via tightening bolts screwed in from above and cooperating with respective fixed threaded nuts 34 on the crash profile 14.

FIG. 5c finally shows again, in a concrete embodiment, a possible fastening of the respective crash profile 27 to the laterally corresponding side sill 22. Here for example, threaded receivers 35 may be arranged on the side sill 22, at which the respective crash profile 27 can be fixed by means of a respective screw which can be pushed through the corresponding cutouts 29. The flange 16, as also shown in FIG. 2, here has a cutout 33 in the region of the screw connection 26, so that in this case the crash profile 27 can be directly fastened to the side sill 22.

### LIST OF REFERENCE SIGNS

1 Housing lower part
2 Sealing flange
3 Sealing flange
4 Housing upper part
5 Seal
6 Steel frame
7 Opening
8 Closing part
9 Aluminum carrier element
10 Steel adapter
11 Leg
12 Leg
13 Opening
14 Crash profile
15 Wall region
16 Flange
17 Profile region
18 Flange
19 Flange
20 Profiled part
21 Screw connection
22 Side sill
23 Threaded bush
24 Screw
Vehicle floor
26 Screw connection
27 Crash profile
28 Cutout
29 Cutout
Chamber
31 Chamber
32 Chamber
33 Cutout
34 Threaded nut
Threaded receiver
36 Energy store
37 Profiled part
38 Washer

1-10. (canceled)

11. A storage housing for an electrical energy store of a motor vehicle, comprising:
at least one housing part having a peripheral sealing flange; and
at least one additional housing part of the storage housing, wherein
the at least one housing part is connected to the additional housing part at the sealing flange,
the at least one housing part comprises a steel frame connected to a closing part made of a light metal material, and
the steel frame is a one-piece shaped component made of steel material.

12. The storage housing according to claim 11, wherein
the light metal material of the closing part is an aluminum material.

13. The storage housing according to claim 11, wherein
the steel frame has a continuous peripheral sealing flange.

14. The storage housing according to claim 11, wherein
the housing part is a housing lower part and the closing part is a floor.

15. The storage housing according to claim 11, wherein
the steel frame has a cathodic dip-coating and is connected to the additional housing part via an adhesive forming a seal.

16. The storage housing according to claim 11, wherein
the steel frame is connected to the closing part by an adhesive forming a seal and by mechanical connectors.

17. The storage housing according to claim 16, wherein
the mechanical connectors are half-hollow punch rivets.

18. The storage housing according to claim 11, wherein
on outer long sides of the steel frame, a respective crash profile is attached, which is made of a steel material, and respective chambers of the crash profile are formed as dry spaces.

19. The storage housing according to claim 18, wherein
a respective crash profile of a steel material, in which respective chambers are configured as dry spaces, is fastened to a front and/or rear end face of the steel frame.

20. The energy store floor assembly according to claim 11, further comprising:
aluminum carrier elements connected to the closing part or floor and arranged inside the steel frame, wherein
the aluminum carrier elements are connected to the steel frame by steel adapters.

21. An energy store floor assembly for an electrically powered motor vehicle, comprising:
side sills of the motor vehicle; and
sills,
a storage housing of an energy store, the storage housing being attached to the side
wherein the storage housing comprises:
at least one housing part having a peripheral sealing flange; and
at least one additional housing part of the storage housing, wherein
the at least one housing part is connected to the additional housing part at the sealing flange,
the at least one housing part comprises a steel frame connected to a closing part made of a light metal material, and
the steel frame is a one-piece shaped component made of steel material.

22. The energy store floor assembly according to claim 21, further comprising:
at least one crash profile, configured separately from the storage housing, attached to the side sills.

23. The energy store floor assembly according to claim 22, wherein
the at least one crash profile is configured as an extruded aluminum profile.
